(19) United States
(12) Patent Application Publication
(10) Pub. No.: US 2012/0327337 A1
(43) Pub. Date: Dec. 27, 2012

(54) COLOR FILTER SUBSTRATE, LIQUID CRYSTAL DISPLAY PANEL AND LIQUID CRYSTAL DISPLAY DEVICE

(75) Inventors: Yusuke Waratani, Osaka-shi (JP); Takaya Uno, Osaka-shi (JP); Yoshitaka Okumoto, Osaka-shi (JP)

(73) Assignee: SHARP KABUSHIKI KAISHA, Osaka-shi, Osaka (JP)

(21) Appl. No.: 13/392,153

(22) PCT Filed: Apr. 21, 2010
(86) PCT No.: PCT/JP2010/057072

§ 371 Date: Sep. 6, 2012

(30) Foreign Application Priority Data
Aug. 28, 2009 (JP) 2009-198305

(51) Int. Cl. G02F 1/1335

(52) U.S. Cl. 349/106

(57) ABSTRACT

The present invention provides a color filter substrate preventing defective displays which may be caused by breakage of an common electrode used for voltage application to a liquid crystal layer in the vicinity of a multilayer spacer due to a stress applied to a liquid crystal display panel, and a liquid crystal display panel and a liquid crystal display device each having the color filter substrate. The color filter substrate of the present invention is a color filter substrate comprising: transparent color layers of a plurality of colors; and an electrode covering the transparent color layers, wherein the color filter substrate includes a multilayer spacer formed by stacking two or more layers including the transparent color layers, and a layer in the multilayer spacer, which is the uppermost layer of the transparent color layers, is separated from a layer around the multilayer spacer, which is one of the transparent color layers.

### TECHNICAL FIELD

The present invention relates to a color filter substrate, a liquid crystal display panel, and a liquid crystal display device.

### BACKGROUND ART

A liquid crystal display device is a display device having a liquid crystal display panel in which a liquid crystal layer is interposed between a pair of substrates. In a liquid crystal display device, an electrode formed on a substrate applies a voltage to a liquid crystal layer to change the alignment mode of the liquid crystal layer. The polarization state of light is thereby changed to conduct displays. Accordingly, a liquid crystal display device is a non-emissive display device which requires a light source aside from a liquid crystal display panel. In such a liquid crystal display device, transparent color layers (color filters) of a plurality of colors are formed on one of a pair of substrates in order to conduct color displays.

In a liquid crystal display device, a spacer is used to control the gap between a pair of substrates, namely, the thickness of a liquid crystal layer. Known spacers include a multilayer spacer formed on a substrate (color filter substrate) on which transparent color layers are to be formed, by stacking transparent color layers of a plurality of colors (see Patent Document 1).
[Patent Document 1]
Japanese Kokai Publication No. 2008-39802 (JP-A 2008-39802)

### DISCLOSURE OF INVENTION

### Problems to be Solved by the Invention

The present inventors have noted that a large stress may be applied to a liquid crystal display panel when a viewer strongly push a screen of a liquid crystal display device with his/her fingers, and such a stress breaks an electrode used for voltage application to a liquid crystal layer in the vicinity of a multilayer spacer. Such breakage of an electrode does not have a great influence if it occurs outside a pixel aperture region. However, if it occurs inside the pixel aperture region, a voltage may not be properly applied to the liquid crystal layer, resulting in defective displays.

The present invention has been devised in consideration of the above state of the art. The present invention is aimed to provide a color filter substrate preventing defective displays which may be caused by breakage of an electrode used for voltage application to a liquid crystal layer in the vicinity of a multilayer spacer due to a stress applied to a liquid crystal display panel, and a liquid crystal display panel and a liquid crystal display device each having the color filter substrate.

### Means for Solving the Problems

The present inventors have intensively studied about breakage of an electrode covering transparent color layers, which may occur on a color filter substrate with a multilayer spacer. Then, the present inventors have found out that a stress applied to a liquid crystal display panel deforms transparent color layers in a multilayer spacer and if the uppermost (liquid-crystal-layer side of the liquid crystal display panel) layer of the transparent color layers in the multilayer spacer is integrated with a transparent color layer around the multilayer spacer, breakage of an electrode may occur because the layer cannot follow the deformation. The present inventors have found out the following solution. Namely, separation of the uppermost layer of the transparent color layers in the multilayer spacer from the transparent color layer around the multilayer spacer surely forms a step portion in the multilayer spacer and deformation of the transparent color layers are concentrated to the step portion. As a result, defective displays can be avoided which are caused by damage of an electrode in a pixel aperture region. Consequently, the present inventors have solved the above problem and arrived at the present invention.

Namely, the present invention is a color filter substrate comprising: transparent color layers of a plurality of colors; and an electrode covering the transparent color layers, wherein the color filter substrate includes a multilayer spacer formed by stacking two or more layers including the transparent color layers, and a layer in the multilayer spacer, which is the uppermost layer of the transparent color layers, is separated from a layer around the multilayer spacer, which is one of the transparent color layers.

Here, the electrode covering the transparent color layers are provided at least in a region where the transparent color layers are formed (pixel aperture region) and is used for voltage application to a liquid crystal layer. On the counter substrate positioned to face the color filter substrate in a liquid crystal display panel, an electrode for voltage application to the liquid crystal layer may be provided in each pixel for active matrix driving. Such an electrode is commonly referred to as a “pixel electrode”. On the other hand, an electrode formed on the color filter substrate for voltage application to the liquid crystal layer is commonly referred to as a “common electrode” because the electrode may be provided on the entire display region to be shared by a plurality of pixels. The electrode covering the transparent color layers may also be a common electrode.

Further, the electrode covering the transparent color layers may or may not constitute apart of the multilayer spacer. In the PSA (Polymer-Sustained Alignment) mode and the like, for example, the electrode on the color filter substrate may be patterned to control alignment of the liquid crystal layer. Accordingly, removal of the common electrode in the multilayer-spacer part at the time of patterning realizes a configuration that no electrode is included in the multilayer spacer. Even in such a case, the common electrode is provided in the pixel aperture region around the multilayer spacer and its peripheral regions.

Hereinafter, a description is given on a preferable embodiment of the color filter substrate of the present invention.

In the preferable embodiment, the multilayer spacer includes the electrode in a layer above the transparent color layers, and a layer stacked directly under the electrode in the multilayer spacer is separated from the layer around the multilayer spacer. In the embodiment where the electrode covering the transparent color layers constitutes apart of the multilayer spacer, damage of the electrode may particularly spread widely, if the layer stacked directly under the electrode in the multilayer spacer is integrated with the transparent color layer around the multilayer spacer. Accordingly, separation of the layer stacked directly under the electrode in the multilayer spacer from the transparent color layer around the multilayer spacer effectively suppresses the damage of the electrode.

In the preferable embodiment, the transparent color layers in the multilayer spacer includes a layer of the same color as the layer around the multilayer spacer, and the layer of the same color as the layer around the multilayer spacer is divided from the layer around the multilayer spacer by a groove. In this embodiment, the transparent color layer around the multilayer spacer is used for formation of the multilayer spacer and is separated from the multilayer spacer by a groove. This effectively prevents damage of the electrode from spreading around the multilayer spacer. The groove is particularly effective if the layer directly covered by the electrode in the multilayer spacer is of the same color as the transparent color layer around the multilayer spacer.

In the preferable embodiment, a first layer consisting of at least one of the transparent color layers in the multilayer spacer is inside a region of a layer directly under the first layer in a plan view of the multilayer spacer. Here, a plan view of the multilayer spacer refers to a plan view of the main surface of the color filter substrate of the present invention. For example, if the multilayer spacer has a configuration in which transparent color layers are stacked in a manner that an upper layer has a smaller area and the electrode covering the multilayer spacer is positioned in the uppermost layer, all the transparent color layers are at least partially covered with the electrode directly. Moreover, with regard to a relation between two adjacent transparent color layers, the upper layer is inside a region of the lower layer. In such an embodiment, the electrode is formed in a step-wise shape. Therefore, the steps effectively prevent damage of the electrode from spreading around the multilayer spacer.

In the preferable embodiment, a second layer consisting of at least one of the transparent color layers in the multilayer spacer is integrated with the layer around the multilayer spacer. Namely, though the uppermost layer among the transparent color layers in the multilayer spacer should be separated from the transparent color layer around the multilayer spacer, layers other than the uppermost layer among the transparent color layers in the multilayer spacer may be integrated with the transparent color layer around the multilayer spacer. Such an embodiment prevents a connection between the multilayer spacer and the transparent color layer therearound through a gradually sloped electrode, preventing damage of the electrode from spreading around the multilayer spacer.

In the preferable embodiment, all the layers in the multilayer spacer are separated from the layer around the multilayer spacer. In this embodiment, it is possible to particularly effectively prevent damage of the electrode from spreading around the multilayer spacer.

The present invention is also a liquid crystal display panel comprising: the color filter substrate; a counter substrate, and a liquid crystal layer interposed between the color filter substrate and the counter substrate. The counter substrate is not particularly limited as long as it is positioned to face the color filter substrate. For example, if the color filter substrate does not have a thin film transistor (TFT) and the like for pixel control, the counter substrate is provided with a TFT and the like for pixel control and is commonly referred to as a TFT substrate or an active matrix substrate. On the other hand, if the color filter has a TFT for pixel control, the counter substrate does not need to have a TFT and the like for pixel control.

In the liquid crystal display panel of the present invention, the multilayer spacer may be a main spacer for controlling the gap between the color filter substrate and the counter substrate. Or alternatively, the multilayer spacer may be a sub spacer designed to have a height lower than the main spacer and supportively functions if the viewer strongly pushes the screen of the liquid crystal display device with his/her fingers. Namely, the counter substrate may be bonded to the color filter substrate to contact with the multilayer spacer or bonded to the color filter substrate to be spaced from the multilayer spacer.

In the case where the multilayer spacer having an electrode in the uppermost layer is used as a main spacer, the counter substrate preferably includes an electrode for voltage application to the liquid crystal layer at a position not overlapping with the multilayer spacer, from the standpoint of preventing a short circuit between the electrode in the multilayer spacer and the electrode on the counter substrate.

The present invention is also a liquid crystal display device comprising the liquid crystal display panel. The liquid crystal display device of the present invention is capable of exerting the same effects as the above-mentioned liquid crystal display panel of the present invention.

Each of the aforementioned embodiments may be appropriately combined in a scope not departing from the principles of the present invention.

### Effect of the Invention

According to the color filter substrate, the liquid crystal display panel, and the liquid crystal display device of the present invention, even if an electrode used for voltage application to a liquid crystal layer is broken in the vicinity of the multilayer spacer due to a stress applied to a liquid crystal display panel, it is possible to prevent damage of the electrode from spreading over a pixel aperture region and to suppress defective displays.

### BRIEF DESCRIPTION OF DRAWINGS

FIG. 1 is a schematic cross-sectional view of a liquid crystal display panel of Embodiment 1.

FIG. 2 is a schematic plan view of a display surface of the liquid crystal display panel of Embodiment 1.

FIG. 3 is a schematic cross-sectional view illustrating a state where a stress is applied to the top portion of a multilayer spacer of Embodiment 1 when the viewer strongly pushes a display surface of the liquid crystal display panel with his/her fingers.

FIG. 4 is a schematic cross-sectional view illustrating a state where a common electrode of Embodiment 1 is broken by the pressure application illustrated in FIG. 3.

FIG. 5 is a schematic cross-sectional view illustrating a modification of the multilayer spacer of Embodiment 1.

FIG. 6 is a schematic cross-sectional view illustrating a modification of the multilayer spacer of Embodiment 1.

FIG. 7 is a schematic cross-sectional view illustrating a modification of the multilayer spacer of Embodiment 1.

FIG. 8 is a schematic cross-sectional view illustrating a multilayer spacer of Embodiment 2.

FIG. 9 is a schematic cross-sectional view illustrating a modification of the multilayer spacer of Embodiment 2.

FIG. 10 is a schematic cross-sectional view illustrating a modification of the multilayer spacer of Embodiment 2.

FIG. 11 is a schematic cross-sectional view illustrating a modification of the multilayer spacer of Embodiment 2.

FIG. 12 is a schematic cross-sectional view illustrating a modification of the multilayer spacer of Embodiment 2.

FIG. 13 is a schematic cross-sectional view illustrating a modification of the multilayer spacer of Embodiment 2.

FIG. 14 is a schematic cross-sectional view illustrating a modification of the multilayer spacer of Embodiment 2.

FIG. 15 is a schematic cross-sectional view illustrating a modification of the multilayer spacer of Embodiment 2.

FIG. 16 is a schematic cross-sectional view illustrating a modification of the multilayer spacer of Embodiment 2.

FIG. 17 is a schematic cross-sectional view illustrating a modification of the multilayer spacer of Embodiment 2.

FIG. 18 is a schematic cross-sectional view illustrating a modification of the multilayer spacer of Embodiment 2.

FIG. 19 is a schematic cross-sectional view illustrating a modification of the multilayer spacer of Embodiment 2.

FIG. 20 is a schematic cross-sectional view illustrating a state where a stress is applied to the top portion of a multilayer spacer of a comparative example when the viewer strongly pushes the display surface of the liquid crystal display panel with his/her fingers.

FIG. 21 is a schematic cross-sectional view illustrating a state where a common electrode is broken by the pressure application illustrated in FIG. 20.

FIG. 22 is a schematic plan view illustrating a state where a common electrode is broken by the pressure application illustrated in FIG. 20.

### MODES FOR CARRYING OUT THE INVENTION

The present invention will be mentioned in more detail referring to the following embodiments, but is not limited to these embodiments.

### Embodiment 1

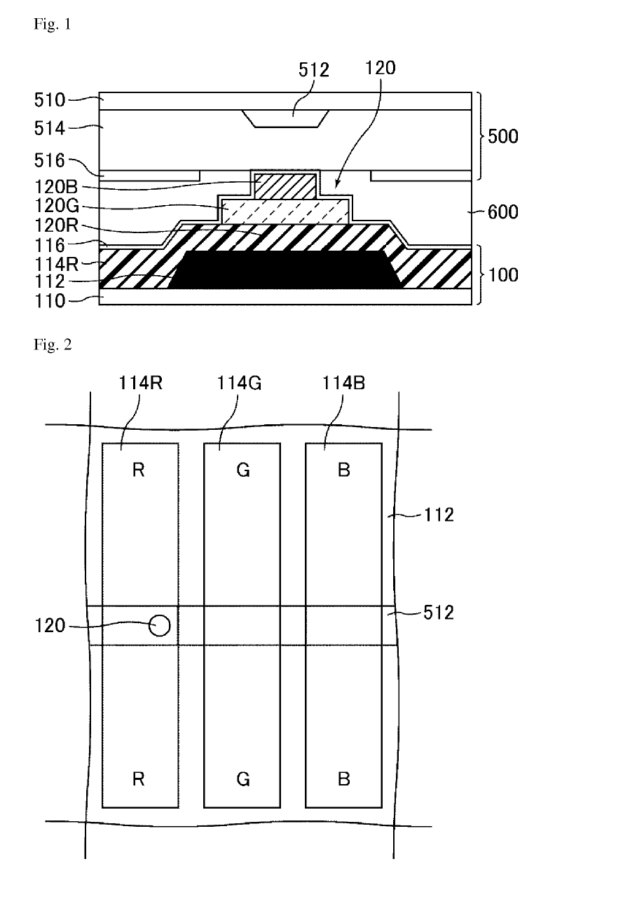

FIG. 1 is a schematic cross-sectional view of a liquid crystal display panel of Embodiment 1. As illustrated in FIG. 1, the liquid crystal display panel of the present embodiment has a configuration in which a liquid crystal layer 600 is interposed between a pair of substrates 100 and 500. A multilayer spacer 120 is provided as a member for controlling the gap between the substrates 100 and 500. The multilayer spacer 120 is formed on a color filter substrate 100 and is in contact with a counter substrate 500 at its uppermost portion after the color filter substrate 100 and the counter substrate 500 are bonded to each other.

As illustrated in FIG. 1, the color filter substrate 100 has a configuration in which transparent color layers 114R, 114G, and 114B of a plurality of colors and a light-shielding layer 112 are positioned on a substrate 110 such as a glass substrate, a resin substrate, and a stainless-steel substrate. In the present embodiment, the counter substrate 500 is a thin film transistor array substrate and has a substrate 510 on which a wiring/electrode 512, an insulating film 514, a pixel electrode 516, and the like are provided.

FIG. 2 is a schematic plan view of a display surface of the liquid crystal display panel of Embodiment 1. As illustrated in FIG. 2, transparent color layers 114R, 114G, 114B of three colors including red, green, and blue are provided in the present embodiment. The transparent color layers are commonly referred to as color filters and can conduct coloring of the display light by transmitting only visible light in a specific wavelength range. Transparent color layers of a plurality of colors arranged in combination realize color displays. A region where the transparent color layers 114R, 114G, 114B are arranged is mainly used as a pixel aperture region.

The light-shielding layer 112 is commonly referred to as a black matrix and is positioned in a region where black displays and light shielding are required, such as a region between the transparent color layers of different colors and a region where a wiring/TFT are positioned. Such a region may also be formed by overlapping the transparent color layers 114R, 114G, and 114B of a plurality of colors without providing the light-shielding layer 112.

In the present embodiment, the multilayer spacer 120 is inside a region where the transparent color layer 114R of red is positioned and the light-shielding layer 112 is further positioned. The region where the multilayer spacer 120 is positioned is commonly not used as a pixel aperture region because the alignment of liquid crystals is influenced by the multilayer spacer 120. Moreover, the multilayer spacer 120 is in contact with the counter substrate 500 in a region where the pixel electrode 516 is not positioned so as not to short due to a contact between the common electrode 116 constituting the top portion thereof and the pixel electrode 516 on the counter substrate 500.

In the following, description is given on the multilayer spacer 120, assuming that the side of the color filter substrate 100 is defined as the bottom side and the side of the counter substrate 500 is defined as the top side as the multilayer spacer 120 is formed on the color filter substrate 100. In the multilayer spacer 120, the light-shielding layer 112, a transparent color layer (spacer red layer) 120R of red, a transparent color layer (spacer green layer) 120G of green, a transparent color layer (spacer blue layer) 120B of blue, and the common electrode 116 are stacked from the bottom side in this order. As seen from the stacking order in the multilayer spacer 120, the light-shielding layer 112, the transparent color layers 114R and 120R of red, the transparent color layers 114G and 120G of green, the transparent color layers 114B and 120B of blue, and the common electrode 116 are formed in this order in the present embodiment.

The spacer red layer 120R is integrally formed with the transparent color layer (red display portion) 114R of red in the pixel aperture region around the multilayer spacer 120. The spacer green layer 120G and the spacer blue layer 120B are respectively separated from the transparent color layer (green display portion) 114G of green and the transparent color layer (blue display portion) 114B of blue in the pixel aperture region. The common electrode 116 is integrally formed in the multilayer spacer 120 and in the pixel aperture region around the multilayer spacer 120.

With regard to the spacer red layer 1208, the spacer green layer 120G, and the spacer blue layer 120B, an upper layer has a smaller area. This configuration provides a margin for a positional shift of the layers during the stacking process, and prevents damage of the common electrode 116 from spreading outside the multilayer spacer 120 in the case where the common electrode 116 is broken by a stress applied to the multilayer spacer 120. Namely, in the configuration that an upper layer has a smaller area, step portions are formed by the vertical side face of the spacer blue layer 120B and the horizontal upper face of the spacer green layer 120G, by the horizontal upper face and the vertical side face of the spacer green layer 120G, and by the vertical side face of the spacer green layer 120G and the horizontal upper face of the spacer red layer 120R. Deformation of the transparent color layers may be concentrated to these step portions. As a result, it is possible to prevent the common electrode 116 outside the multilayer spacer 120 from being damaged.

If the common electrode 116 in contact with the horizontal upper face of the spacer blue layer 120B is broken to have a crack by stress application, the crack tends to propagate in the horizontal upper face of the spacer blue layer 120B but the edge formed by the horizontal upper face and the vertical side face of the spacer blue layer 120B can prevent further crack propagation. Similarly, crack propagation may be prevented by the edge formed by the vertical side face of the spacer blue layer 120B and the horizontal upper face of the spacer green layer 120G, the edge formed by the horizontal upper face and the vertical side face of the spacer green layer 120G, and the edge formed by the vertical side face of the spacer green layer 120G and the horizontal upper face of the spacer red layer 120R.

If a stress is applied to the liquid crystal display panel, the stress is concentrated to the part contacting with the counter substrate 500. Therefore, the common electrode 116 contacting with the horizontal upper face of the spacer blue layer 120B is especially likely to be broken. In order to prevent a crack in the common electrode 116 from propagating into the pixel aperture region outside the multilayer spacer 120, it is important to narrow the upper face of the spacer blue layer 120B stacked directly under the common electrode 116. In the present embodiment, the transparent color layer 120B of blue is separated from the transparent color layer 114R of red around the multilayer spacer 120. Therefore, cracking of the common electrode 116 is sufficiently suppressed in the pixel aperture region.

A method for forming the transparent color layers 114R and 120R of red, the transparent color layers 114G and 120G of green, and the transparent color layers 114B and 120B of blue is not particularly limited, and examples thereof include the following methods. One method comprises the step of applying a photosensitive resin material to the substrate 110 using a coater to form a photosensitive resin film and patterning the photosensitive resin film by photolithography. Another method comprises the step of transferring a photosensitive resin film to the substrate 110 using a dry film provided with the photosensitive film on the base and patterning the photosensitive resin film by photolithography.

Materials of the transparent color layers 114R, 114G, 114B, 120R, 120G, and 120B may be resin materials such as photosensitive resins. The material of the common electrode 116 may be indium tin oxide (ITO), indium zinc oxide (IZO), or the like. The materials of the transparent color layers and of the common electrode are commonly different and the common electrode may have conventionally failed to follow the deformation of the transparent color layers, leading to damage thereof.

FIG. 3 is a schematic cross-sectional view illustrating a state where a stress is applied to the top portion of the multilayer spacer 120 of Embodiment 1 when the viewer strongly pushes the display surface of the liquid crystal display panel with his/her fingers. Especially, in display devices of mobile equipment and display devices having touch panels, the display surface of the liquid crystal display panel is likely to be strongly pushed by viewers with their fingers. In such a situation, a stress may be applied to the top portion of the multilayer spacer 120 as illustrated in FIG. 3.

In the multilayer spacer 120 of the present embodiment, an upper layer has a smaller area among the spacer red layer 120R, the spacer green layer 120G, and the spacer blue layer 120B. Accordingly, as illustrated in a cross-sectional view of FIG. 4 that schematically illustrates a state where the common electrode 116 of the present embodiment is broken by the stress application of FIG. 3, cracks in the common electrodes 116 propagate in the horizontal upper face of the spacer blue layer 120B but do not reach the pixel aperture region outside the multilayer spacer 120 as crack propagation is efficiently suppressed by a plurality of step portions (edge formed by a horizontal upper face and a vertical side face) in the multilayer spacer 120.

It is to be noted that the multilayer spacer 120 of the present embodiment may be modified without departing from the intension to narrow the area of the upper face of the layer stacked directly under the common electrode 116.

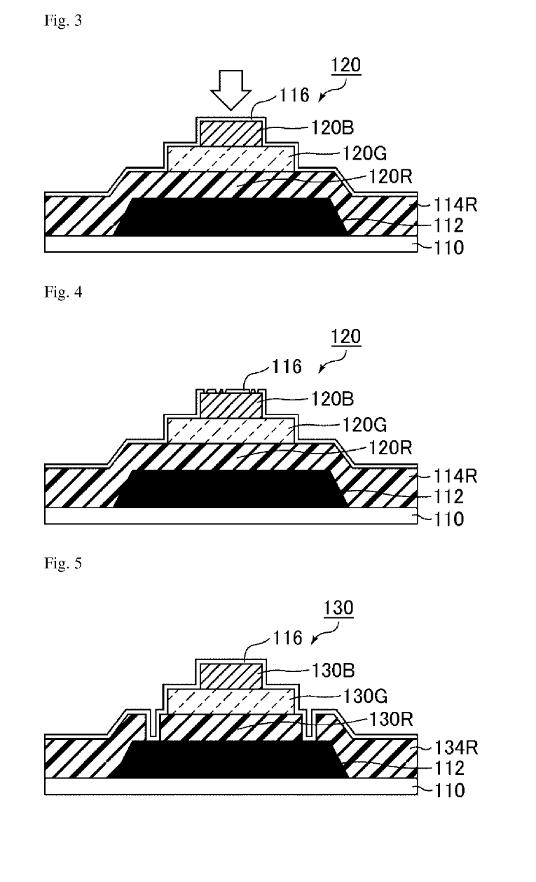

FIGS. 5 to 7 are schematic cross-sectional views each illustrating a modification of the multilayer spacer 120 of Embodiment 1. In a multilayer spacer 130 of FIG. 5, a groove is formed to separate a spacer red layer 130R from a red display portion 134R. This groove forms step portions between the horizontal upper face of the spacer blue layer 134B and the red display portion 134R, resulting in increase in the number of step portions. Moreover, since the position of the common electrode 116 in the groove is lower than the position of the common electrode 116 on the red display portion 134R, the integrity between the common electrode 116 inside the multilayer spacer 130 and the common electrode 116 outside the multilayer spacer 130 is significantly lowered. As a result, cracking of the common electrode 116 are particularly effectively prevented in the pixel aperture region.

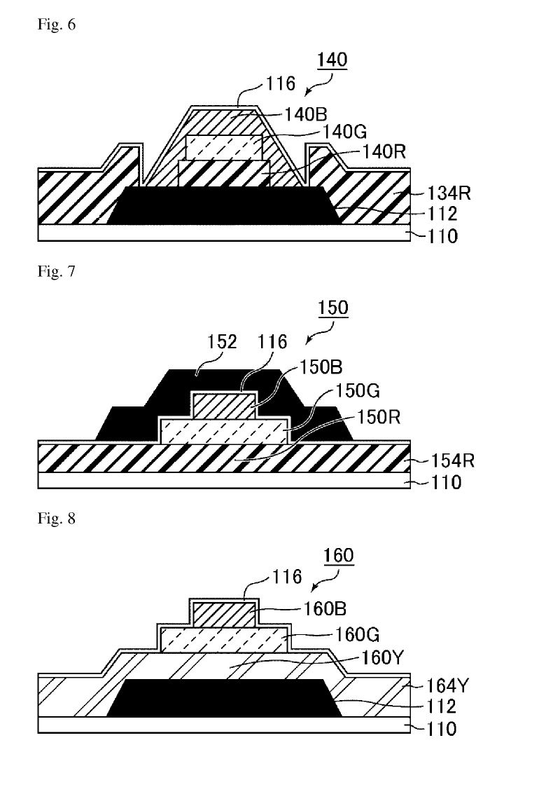

In a multilayer spacer 140 of FIG. 6, a groove is formed to separate a spacer red layer 140R from a red display portion 134R and a spacer blue layer 140B covers the spacer red layer 140R and a spacer green layer 140G. In the case where a groove is formed to separate the spacer red layer 140R from the red display portion 134R, the integrity between the common electrode 116 inside the multilayer spacer 140 and the common electrode 116 outside the multilayer spacer 140 is significantly lowered. As a result, it is possible to form the spacer blue layer 140B in the groove.

In a multilayer spacer 150 of FIG. 7, the stacking order of layers is changed. A transparent color layer 150R of red, a transparent color layer 150G of green, a transparent color layer 150B of blue, a common electrode 116, and a light-shielding layer 152 are formed in this order. Even in this case where the common electrode 116 and a counter substrate 500 are not directly in contact with each other, the common electrode 116 tends to be damaged at the uppermost portion in the multilayer spacer 150. Also in such a case, narrowing of the area of the top face of the spacer blue layer 150B stacked directly under the common electrode 116 can suppresses cracking of the common electrode 116 in the pixel aperture region.

### Embodiment 2

The liquid crystal display panel of Embodiment 1 has transparent color layers of three colors including red, green, and blue. In the present embodiment, the liquid crystal display panel has transparent color layers of four colors including red, green, blue, and yellow. By increasing the number of colors, it is possible to enhance the display quality such as expansion of the color reproduction range in color displays. At the same time, however, problems may arise such as lowering of production efficiency and need for redesigning the production line due to the increase in the number of production steps. To solve such problems, it is possible to suppress the increase in the number of production steps by utilizing the technique of omitting a component for controlling the alignment of liquid crystals which has been formed in a conventional liquid crystal display device in the vertical alignment mode. Accordingly, a transparent color layer of yellow can be added without redesigning the conventional production line. However, the transparent color layers of these colors are different from the component for controlling the alignment of liquid crystals in that these layers are preferably formed in lower layers compared to an electrode used for voltage application to a liquid crystal layer so that the electrode functions sufficiently. Accordingly, in the case where transparent color layers of four colors including red, green, blue, and yellow are formed, the electrode used for voltage application to a liquid crystal layer is likely to be formed in the uppermost layers of the multilayer spacer and in contact with a counter substrate. In such a configuration, the electrode is problematically easily broken when an external force is applied to the liquid crystal display panel.

FIG. 8 is a schematic cross-sectional view illustrating a multilayer spacer of Embodiment 2. In the present embodiment, a multilayer spacer 160 is inside a region where a transparent color layer 164Y of yellow is positioned and a light-shielding layer 112 is further positioned. In the multilayer spacer 160, a light shielding layer 112, a transparent color layer (spacer yellow layer) 160Y of yellow, a transparent color layer (spacer green layer) 160G of green, a transparent color layer (spacer blue layer) 160B of blue, and a common electrode 116 are stacked in this order from the bottom. As seen from the stacking order in the multilayer spacer 160, the light-shielding layer 112, the transparent color layer 160Y of yellow, the transparent color layer 160G of green, the transparent color layer 160B of blue, and the common electrode 116 are formed in this order in the present embodiment. The timing of forming a transparent color layer of red is not particularly limited as long as it is prior to the formation of the common electrode 116 as the transparent color layer of red is not included in the multilayer spacer 160.

The spacer yellow layer 160Y is formed integrally with a transparent color layer (yellow display portion) 164Y of yellow around the multilayer spacer 160. The spacer green layer 160G and the spacer blue layer 160B are respectively separated from a transparent color layer (green display portion) of green and a transparent color layer (blue display portion) of blue in the pixel aperture region. The common electrode 116 is formed integrally inside the multilayer spacer 160 and in the pixel aperture region around the multilayer spacer 160.

With regard to the spacer yellow layer 160Y, the spacer green layer 160G, and the spacer blue layer 160B, an upper layer has a smaller area. This configuration provides a margin for a positional shift of the layers during the stacking process, and also prevents damage of the common electrode 116 from spreading outside the multilayer spacer 160 in the case where the common electrode 116 is broken by a stress applied to the multilayer spacer 160. Namely, in the configuration that an upper layer has a smaller area, step portions are formed by the vertical side face of the spacer blue layer 160B and the horizontal upper face of the spacer green layer 160G, by the horizontal upper face and the vertical side face of the spacer green layer 160G, and by the vertical side face of the spacer green layer 160G and the horizontal upper face of the spacer yellow layer 160Y. Deformation of the transparent color layers may be concentrated to these step portions. As a result, it is possible to prevent the common electrode 116 from being damaged outside the multilayer spacer 160.

If the common electrode 116 in contact with the horizontal upper face of the spacer blue layer 160B is broken to have a crack by stress application, the crack tends to propagate in the horizontal upper face of the spacer blue layer 160B but the edge formed by the horizontal upper face and the vertical side face of the spacer blue layer 160B can prevent further crack propagation. Similarly, crack propagation may be prevented by the edge formed by the vertical side face of the spacer blue layer 160B and the horizontal upper face of the spacer green layer 160G, the edge formed by the horizontal upper face and the vertical side face of the spacer green layer 160G, and the edge formed by the vertical side face of the spacer green layer 160G and the horizontal upper face of the spacer yellow layer 160Y.

If a stress is applied to the liquid crystal display panel, the stress is concentrated to the part in contact with the counter substrate 500. Therefore, the common electrode 116 in contact with the horizontal upper face of the spacer blue layer 160B is especially likely to be broken. In order to prevent the crack in the common electrode 116 from propagating into the pixel aperture region outside the multilayer spacer 160, it is important to narrow the upper face of the spacer blue layer 160B stacked directly under the common electrode 116. In the present embodiment, the transparent color layer 160B of blue is separated from the transparent color layer 164Y of yellow around the multilayer spacer 160. Therefore, cracking of the common electrode 116 is sufficiently suppressed in the pixel aperture region.

A method for forming the transparent color layers 160Y and 164Y of yellow, the transparent color layer 160G of green, and the transparent color layer 160B of blue is not particularly limited, and examples thereof include the following methods. One method comprises the step of applying a photosensitive resin material to the substrate 110 using a coater to form a photosensitive resin film and patterning the photosensitive resin film by photolithography. Another method comprises the step of transferring a photosensitive resin film to the substrate 110 using a dry film provided with the photosensitive film on the base and patterning the photosensitive resin film by photolithography.

It is to be noted that the multilayer spacer 160 of the present embodiment may be modified without departing from the intension to narrow the area of the upper face of the layer stacked directly under the common electrode 116.

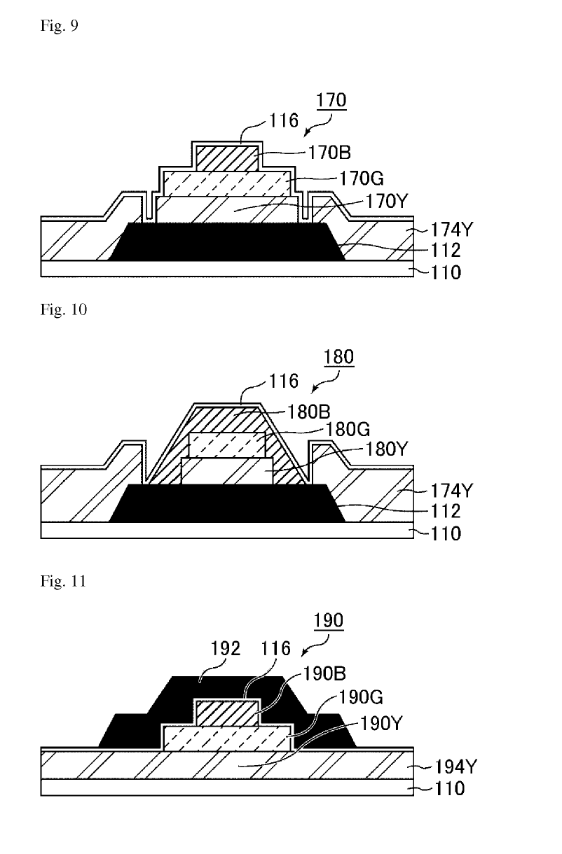

FIGS. 9 to 19 are schematic cross-sectional views each illustrating a modification of the multilayer spacer of Embodiment 2. In a multilayer spacer 170 of FIG. 9, a groove is formed to separate a spacer yellow layer 170Y from a yellow display portion 174Y. This groove forms step portions between the horizontal upper face of the spacer yellow layer 170Y and the yellow display portion 174Y, resulting in increase in the number of step portions. Moreover, since the position of the common electrode 116 in the groove is lower than the position of the common electrode 116 on the yellow display portion 174Y, the integrity between the common electrode 116 inside the multilayer spacer 170 and the common electrode 116 outside the multilayer spacer 170 is significantly lowered. As a result, cracking of the common electrode 116 is particularly effectively prevented in the pixel aperture region.

In a multilayer spacer 180 of FIG. 10, a groove is formed to separate a spacer yellow layer 180Y from a yellow display portion 174Y and a spacer blue layer 180B covers the spacer yellow layer 180Y and a spacer green layer 180G. In the case where a groove is formed to separate the spacer yellow layer 180Y and the yellow display portion 174Y, the integrity between the common electrode 116 inside the multilayer spacer 180 and the common electrode 116 outside the multilayer spacer 180 is significantly lowered. As a result, it is possible to form the spacer blue layer 180B in the groove.

In a multilayer spacer 190 of FIG. 11, the stacking order of layers is changed. A transparent color layer 190Y of yellow, a transparent color layer 190G of green, a transparent color layer 190B of blue, a common electrode 116, and a light-shielding layer 192 are formed in this order. Even in this case where the common electrode 116 and a counter substrate 500 are not directly in contact with each other, the common electrode 116 tends to be damaged at the uppermost portion in the multilayer spacer 190. Also in such a case, narrowing of the top face of the spacer blue layer 190B stacked directly under the common electrode 116 can suppresses cracking of the common electrode 116 in the pixel aperture region.

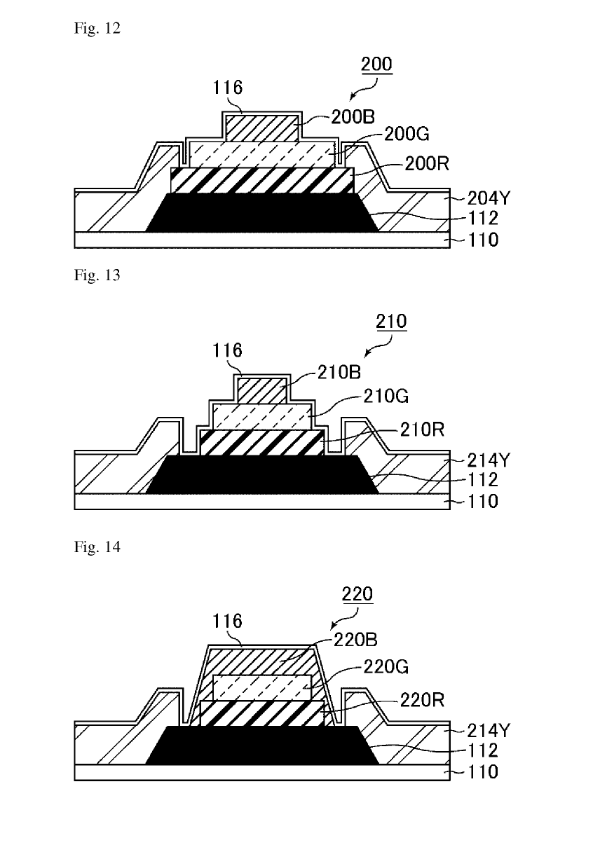

In a multilayer spacer 200 of FIG. 12, a spacer red layer 200R is placed instead of a spacer yellow layer. Namely, a transparent color layer 204Y around the multilayer spacer 200 is not included in the multilayer spacer 200. In such an embodiment, cracking of the common electrode 116 in the pixel aperture region can be suppressed.

In a multilayer spacer 210 of FIG. 13, a spacer red layer 210R is placed instead of a spacer yellow layer and a groove is formed to separate the multilayer spacer 210 from a yellow display portion 214Y. In such an embodiment, cracking of the common electrode 116 in the pixel aperture region can be suppressed.

In a multilayer spacer 220 of FIG. 14, a spacer red layer 220R is placed instead of a spacer yellow layer, a groove is formed to separate the multilayer spacer 220 from a yellow display portion 214Y, and a spacer blue layer 220B covers the spacer red layer 220R and the spacer green layer 220G. In such an embodiment, cracking of the common electrode 116 in the pixel aperture region can be suppressed.

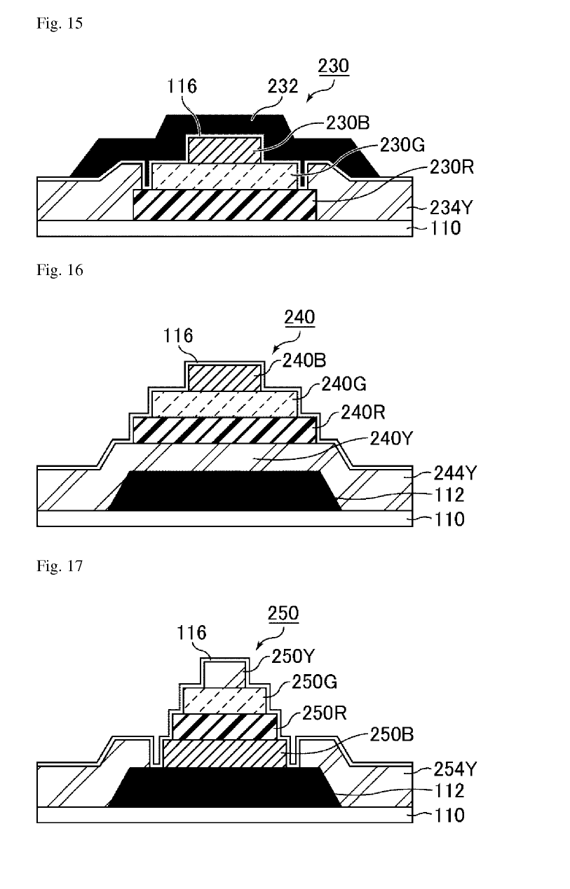

In a multilayer spacer 230 of FIG. 15, a spacer red layer 230R is placed instead of a spacer yellow layer and the stacking order of layers is changed. Namely, a transparent color layer 230R of red, a transparent color layer 230G of green, a transparent color layer 230B of blue, a common electrode 116, and a light-shielding layer 232 are formed in this order. Formation of the transparent color layer 234Y of yellow is after the transparent color layer 230R of red is formed and before the common electrode 116 is formed. In such an embodiment, cracking of the common electrode 116 in the pixel aperture region can be suppressed.

In a multilayer spacer 240 of FIG. 16, a spacer red layer 240R is added between a spacer yellow layer 240Y and a spacer green layer 240G. Namely, the transparent color layers constituting the multilayer spacer 240 is changed from three colors including red, green, and blue to four colors including red, green, blue, and yellow. In such an embodiment, cracking of the common electrode 116 in the pixel aperture region can be suppressed.

In a multilayer spacer 250 of FIG. 17, a spacer red layer 250R is added and the stacking order of layers is changed. Namely, a light-shielding layer 112, a transparent color layer 250B of blue, a transparent color layer 250R of red, transparent color layer 250G of green, a transparent color layer 250Y of yellow, and a common electrode 116 are formed in this order. In addition, a groove is formed to separate the multilayer spacer 250 from a yellow display portion 254Y. In such an embodiment, cracking of the common electrode 116 in the pixel aperture region can be suppressed.

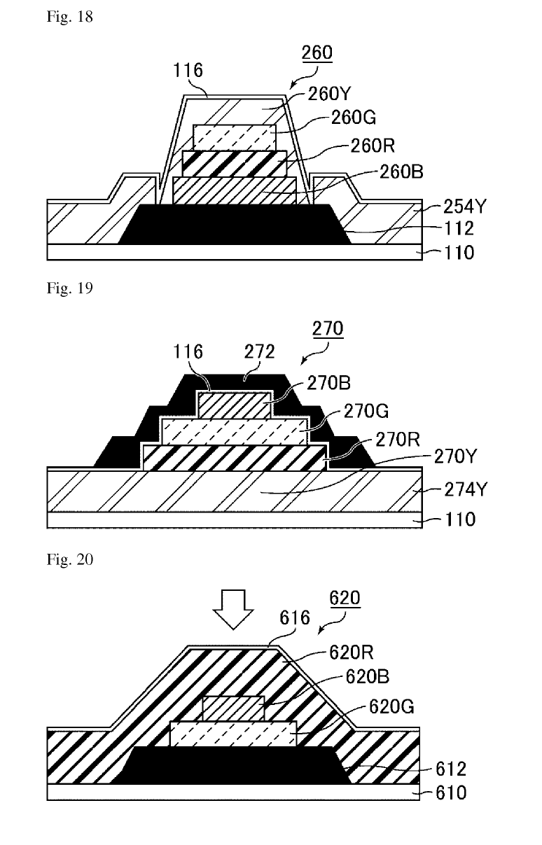

In a multilayer spacer 260 of FIG. 18, a spacer red layer 260R is added and the stacking order of layers is changed. Namely, a light-shielding layer 112, a transparent color layer 260B of blue, a transparent color layer 260R of red, transparent color layer 260G of green, a transparent color layer 260Y of yellow, and a common electrode 116 are formed in this order. In addition, a groove is formed to separate the multilayer spacer 260 from a yellow display portion 254Y, and the spacer yellow layer 260Y covers the spacer green layer 260G, the spacer red layer 260R, and the spacer blue layer 260B. In such an embodiment, cracking of the common electrode 116 in the pixel aperture region can be suppressed.

In a multilayer spacer 270 of FIG. 19, a spacer red layer 270R is added between a spacer yellow layer 270Y and a spacer green layer 270G, and the stacking order of layers is changed. Namely, a transparent color layer 270Y of yellow, a transparent color layer 270R of red, transparent color layer 270G of green, a transparent color layer 270B of blue, a common electrode 116, and a light-shielding layer 272 are formed in this order. In such an embodiment, cracking of the common electrode 116 can be suppressed.

### Comparative Example

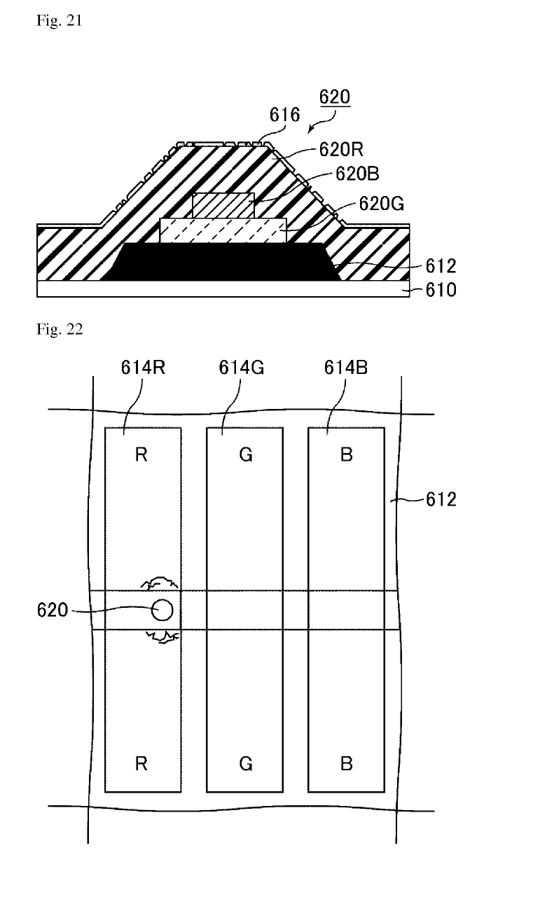

FIG. 20 is a schematic cross-sectional view illustrating a state where a stress is applied to the top portion of a multilayer spacer of a comparative example when the viewer strongly pushes the display surface of the liquid crystal display panel with his/her fingers. As illustrated in FIG. 20, in a multilayer spacer 620 of the comparative example, a light-shielding layer 612, a transparent color layer (spacer green layer) 620G of green, a transparent color layer (spacer blue layer) 620B of blue, a transparent color layer (spacer red layer) 620R of red, and a common electrode 616 are formed in this order from the bottom side. The spacer red layer 620R is integrally formed with a transparent color layer (red display portion) 614R of red in the aperture region around the multilayer spacer 620.

As illustrated in FIG. 20, if a stress is applied to the top portion of the multilayer spacer 620, the common electrode 616 cannot follow the deformation of the spacer red layer 620R, resulting in breakage of the common electrode 616. A schematic cross-sectional view of FIG. 21 and a schematic plan view of FIG. 22 each illustrate a state where the common electrode 616 is broken by the pressure application illustrated in FIG. 20. As illustrated in FIGS. 21 and 22, cracks in the common electrode 616 propagate not only into the multilayer spacer 620 but also into the region of the transparent color layer 614R of red around the multilayer spacer 620. If the cracks in the common electrode 616 propagate into the pixel aperture region, the alignment in a liquid crystal layer 600 cannot be controlled as desired by voltage application to the liquid crystal layer or the peeled common electrode 616 shorts with a pixel electrode on the counter substrate in the region where cracks appeared, resulting in defective displays.

The embodiments described above may be employed in combination without departing from the scope of the present invention.

The present application claims priority to Patent Application No. 2009-198305 filed in Japan on Aug. 28, 2009 under the Paris Convention and provisions of national law in a designated State, the entire contents of which are hereby incorporated by reference.

### EXPLANATION OF NUMERALS AND SYMBOLS

100 Color filter substrate
110 Substrate
112 Light-shielding layer
114B Blue display portion
114G Green display portion
114R Red display portion
116 Common electrode
120 Multilayer spacer
120B Spacer blue layer
120G Spacer green layer
120R Spacer red layer
130 Multilayer spacer
130B Spacer blue layer
130G Spacer green layer
130R Spacer red layer
134R Red display portion
140 Multilayer spacer
140B Spacer blue layer
140G Spacer green layer
140R Spacer red layer
150 Multilayer spacer
150B Spacer blue layer
150G Spacer green layer
150R Spacer red layer
152 Light-shielding layer
154R Red display portion
160 Multilayer spacer
160B Spacer blue layer
160G Spacer green layer
160Y Spacer yellow layer
164Y Yellow display portion
170 Multilayer spacer
170B Spacer blue layer
170G Spacer green layer
170Y Spacer yellow layer
174Y Yellow display portion
180 Multilayer spacer
180B Spacer blue layer
180G Spacer green layer
180Y Spacer yellow layer
190 Multilayer spacer
190B Spacer blue layer
190G Spacer green layer
190Y Spacer yellow layer
192 Light-shielding layer
194Y Yellow display portion
200 Multilayer spacer
200B Spacer blue layer
200G Spacer green layer
200R Spacer red layer
204Y Yellow display portion
210 Multilayer spacer
210B Spacer blue layer
210G Spacer green layer
210R Spacer red layer
214Y Yellow display portion
220 Multilayer spacer
220B Spacer blue layer
220G Spacer green layer
220R Spacer red layer
230 Multilayer spacer
230B Spacer blue layer
230G Spacer green layer
230R Spacer red layer
232 Light-shielding layer
234Y Yellow display portion
250 Multilayer spacer
250B Spacer blue layer
250G Spacer green layer
250R Spacer red layer
250Y Spacer yellow layer
254Y Yellow display portion
260 Multilayer spacer
260B Spacer blue layer
260G Spacer green layer
260R Spacer red layer
260Y Spacer yellow layer
270 Multilayer spacer
270B Spacer blue layer
270G Spacer green layer
270R Spacer red layer
270Y Spacer yellow layer
272 Light-shielding layer
274Y Yellow display portion
500 Counter substrate
510 Substrate
512 Wiring/electrode
514 Insulating film
516 Pixel electrode
600 Liquid crystal layer
610 Substrate
612 Light-shielding layer
614B Blue display portion
614G Green display portion
614R Red display portion
616 Common electrode
620 Multilayer spacer
620B Spacer blue layer
620G Spacer green layer
620R Spacer red layer

1. A color filter substrate comprising:
transparent color layers of a plurality of colors; and
an electrode covering the transparent color layers,
wherein the color filter substrate includes a multilayer spacer formed by stacking two or more layers including the transparent color layers, and
a layer in the multilayer spacer, which is the uppermost layer of the transparent color layers, is separated from a layer around the multilayer spacer, which is one of the transparent color layers.

2. The color filter substrate according to claim 1,
wherein the multilayer spacer includes the electrode in a layer above the transparent color layers, and
a layer stacked directly under the electrode in the multilayer spacer is separated from the layer around the multilayer spacer.

3. The color filter substrate according to claim 1,
wherein the transparent color layers in the multilayer spacer includes a layer of the same color as the layer around the multilayer spacer, and
the layer of the same color as the layer around the multilayer spacer is divided from the layer around the multilayer spacer by a groove.

4. The color filter substrate according to claim 2,
wherein a first layer consisting of at least one of the transparent color layers in the multilayer spacer is inside a region of a layer directly under the first layer in a plan view of the multilayer spacer.

5. The color filter substrate according to claim 1,
wherein a second layer consisting of at least one of the transparent color layers in the multilayer spacer is integrated with the layer around the multilayer spacer.

6. The color filter substrate according to claim 1,
wherein all the layers in the multilayer spacer are separated from the layer around the multilayer spacer.

7. A liquid crystal display panel comprising:
the color filter substrate according to claim 1;
a counter substrate, and
a liquid crystal layer interposed between the color filter substrate and the counter substrate.

8. The liquid crystal display panel according to claim 7,
wherein the counter substrate is bonded to the color filter substrate to contact with the multilayer spacer.

9. The liquid crystal display panel according to claim 8,
wherein the electrode is positioned in the uppermost layer of the multilayer spacer, and
the counter substrate includes an electrode for voltage application to the liquid crystal layer at a position not overlapping with the multilayer spacer.

10. The liquid crystal display panel according to claim 7,
wherein the counter substrate is bonded to the color filter substrate to be spaced from the multilayer spacer.

11. A liquid crystal display device comprising
the liquid crystal display panel according to claim 7.
